(19) United States
(12) Patent Application Publication
(10) Pub. No.: US 2007/0011883 A1
(43) Pub. Date: Jan. 18, 2007

(54) Mark having identifying device

(76) Inventor: Ming Yen Chang, Changhua Hsien (TW)

Correspondence Address: CHARLES E. BAXLEY, ESQ., 90 JOHN STREET, THIRD FLOOR, NEW YORK, NY, 10038, US

(21) Appl. No.: 11/176,568

(22) Filed: Jul. 6, 2005

(51) Int. Cl. B26B 3/00

(52) U.S. Cl. 30/164.95

(57) ABSTRACT

A mark device includes a base member, and a mark having one or more mark pieces disposed on the base member, and one or more identifying devices for identifying whether the mark pieces or the mark is true or authentic or not. The identifying device includes one or more reduced mark pieces disposed in the mark piece, or disposed in the base member. A light generating device may be used for lighting onto the identifying device, or a magnifying device may be used for magnifying the identifying device, to allow the identifying device to be seen by people, and for identifying the truthfulness or authenticity of the mark device, and for preventing unauthorized persons from imitating or copying the mark device.

### BACKGROUND OF THE INVENTION

1. Field of the Invention

The present invention relates to a mark, and more particularly to a mark device having an identifying or anti-infringing device provided therein for identifying the truthfulness or authenticity of the mark device, and for preventing unauthorized persons from imitating or copying the mark device.

2. Description of the Prior Art

Typical marks or mark labels simply comprise the words or the patterns of the marks provided thereon, such as applied onto the mark labels with painting or printing processes, or attached onto the mark labels with stitching or securing processes, or directly attached onto the marked products with molding processes.

For example, many of the typical marks or mark labels comprise one or more words or patterns or symbols provided on a base member, and having planar or shiny outer surfaces or outer appearances, formed by such as electroplating processes, to allow shiny outer surfaces or outer appearances to be seen by people, when the typical marks or mark labels are tilted relative to a light source.

Normally, the words or the patterns of the marks may be easily copied or imitated by the others with the typical electroplating processes, and may not be easily identified whether the mark device is true or authentic or not.

The present invention has arisen to mitigate and/or obviate the afore-described disadvantages of the conventional mark devices.

### SUMMARY OF THE INVENTION

The primary objective of the present invention is to provide a mark device including an identifying or anti-infringing device provided therein for identifying the truthfulness or authenticity of the mark device, and for preventing unauthorized persons from imitating or copying the mark device.

The other objective of the present invention is to provide a mark device including one or more mark pieces and/or one or more identifying or anti-infringing devices provided on a base member, and arranged for allowing the identifying or anti-infringing devices to be seen via a magnifying device or a light generating device.

In accordance with one aspect of the invention, there is provided a mark device comprising a base member, a mark including at least one mark piece provided on the base member, and an identifying device for identifying whether the mark piece is true or authentic or not.

The identifying device includes at least one reduced mark piece provided in the mark piece, and/or provided in the base member. A light generating device may further be provided for lighting onto the identifying device, to allow the identifying device to be seen by people, and for identifying the truthfulness or authenticity of the mark device, and for preventing unauthorized persons from imitating or copying the mark device.

Alternatively, a magnifying device may further be provided for magnifying the identifying device, to allow the identifying device to be seen by people.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a mark device in accordance with the present invention;

FIG. 2 is an enlarged perspective view of the mark device;

FIG. 3 is a further enlarged partial perspective view of the mark device;

FIG. 4 is a perspective view similar to FIG. 1, illustrating the other arrangement of the mark device; and

FIG. 5 is a flow chart illustrating the manufacturing operation or processes for making the mark device.

### DETAILED DESCRIPTION OF THE PREFERRED EMBODIMENT

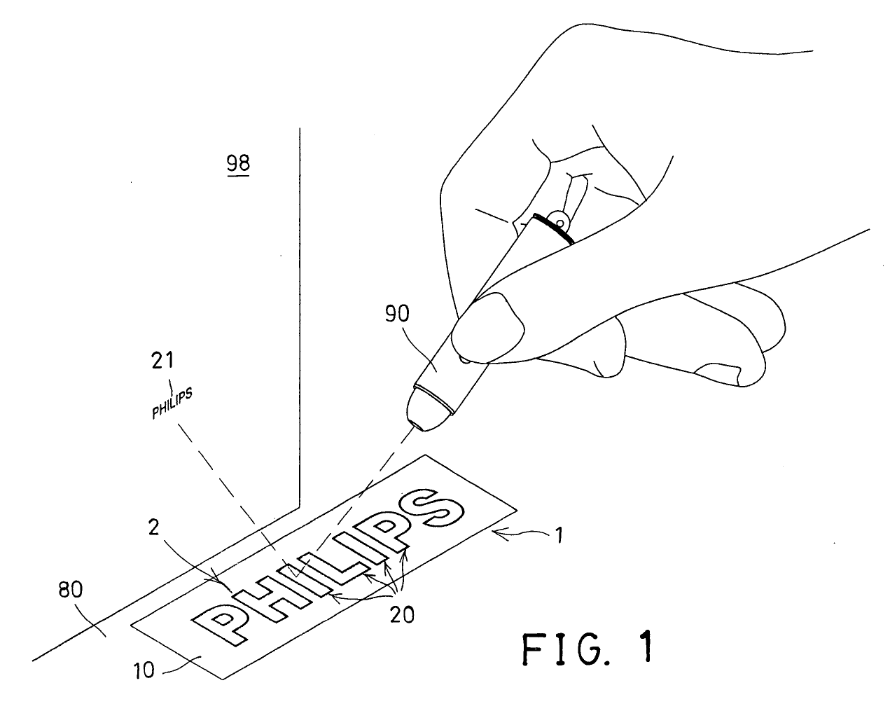

Referring to the drawings, and initially to FIG. 1, a mark device 1 in accordance with the present invention comprises a basic label or base member 10 including a mark 2 having one or more words, patterns or symbols or mark pieces 20 disposed or attached or applied or provided on the base member 10. For example, the words, patterns or symbols or mark pieces 20 or the mark 2 may be attached or applied onto the base member 10 first, and the base member 10 may then be attached onto the products 80, or the words, patterns or symbols or mark pieces 20 may be directly attached or applied onto the products 80.

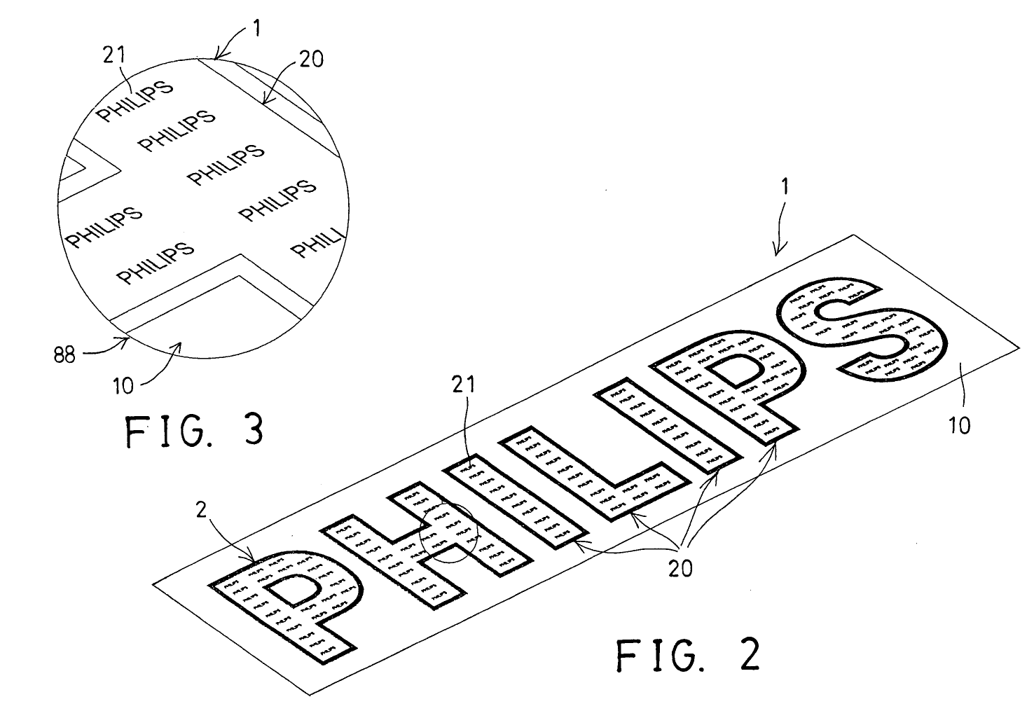

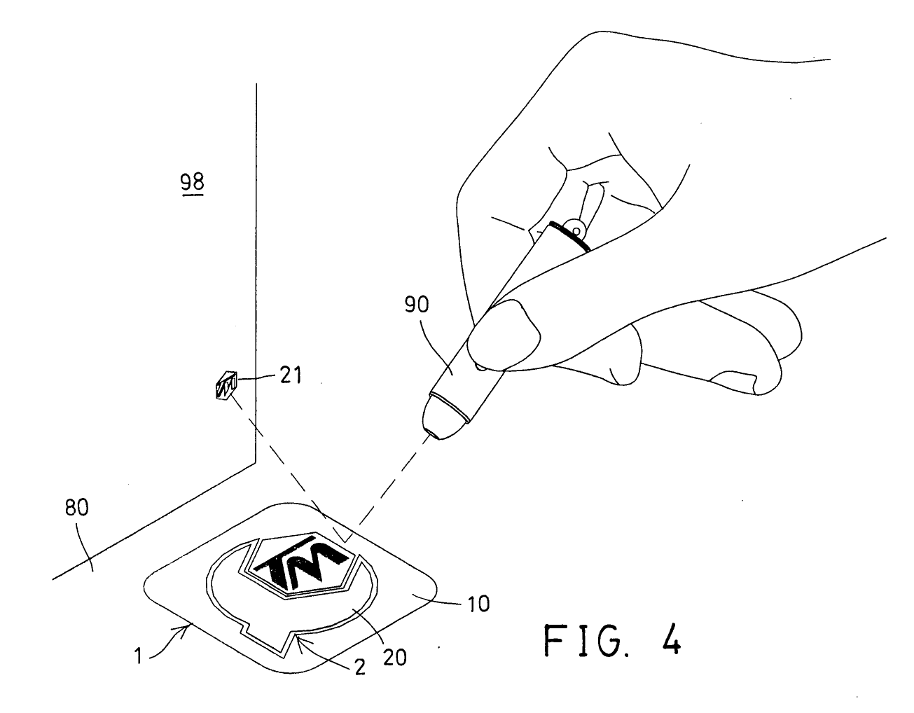

As shown in FIGS. 2, 3, the base member 10 may include an identifying or anti-infringing means or device 21 provided therein, such as formed or provided in the base member 10 itself (FIG. 4), or formed or provided in the words, patterns or symbols or mark pieces 20 (FIGS. 1-3), for identifying the truthfulness or authenticity of the mark device 1, and for preventing unauthorized persons from imitating or copying the mark device 1. For example, the identifying or anti-infringing device 21 may be identical to the mark 2, or may include one or more reduce-sized or area-reduced words, patterns or symbols or mark pieces 20 or marks 2, or may include one or more words, patterns or symbols or mark pieces 20 or marks 2 having a reduced size or area as compared with the mark 2.

As shown in FIGS. 2 and 3, it is preferable that the identifying or anti-infringing device 21 may not be clearly seen by people, but may be seen through magnifying glasses 88 (FIG. 3), or may be seen when tilting the mark 2 or the words, patterns or symbols or mark pieces 20 relative to a light source, or by an infrared-ray or laser beam or light generating device 90 (FIGS. 1, 4) which may light onto the identifying or anti-infringing device 21, to allow the identifying or anti-infringing device 21 to be directly seen by people, or to allow the identifying or anti-infringing device 21 to be reflected onto a wall member 98, and then to be seen by people, as also shown in FIGS. 1 and 4.

For example, the identifying or anti-infringing device 21 may be treated or colored to generate various colors when the identifying or anti-infringing device 21 is lighted by the infrared-ray or laser beam generating device 90, to allow the users or people to see the colored identifying or anti-infringing device 21, and thus to identify that the identifying or anti-infringing device 21 and thus the words, patterns or symbols or mark pieces 20 are truth or authentic.

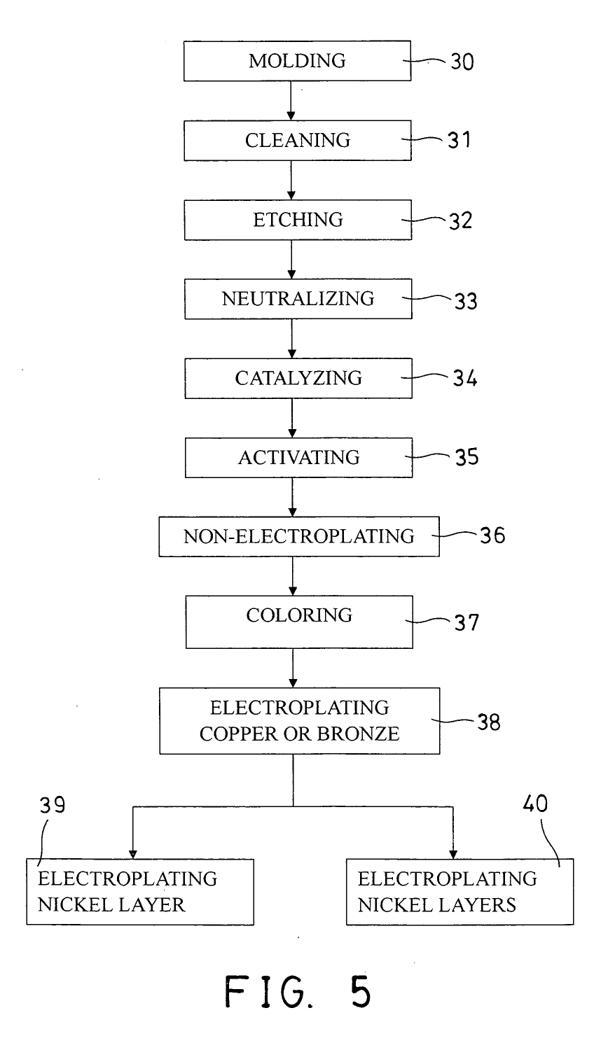

For making or for forming the identifying or anti-infringing device 21 on the mark pieces 20 and/or on the base member 10, as shown in FIG. 5, the base member 10 may first be molded to form recessed or protruded words, patterns or symbols or mark pieces 20 and/or recessed or protruded identifying or anti-infringing devices 21 therein, in process 30, and then cleaned in process 31 with such as various acid or alkali solutions, to remove grease or oil from the base member 10. The base member 10 is then subjected with an etching process 32, with such as acid solutions, to form cavities or perforations therein.

After the etching process 32, the base member 10 is then preferably subjected with a neutralizing process 33, in order to neutralize the acid or alkali solutions. The base member 10 is then subjected with a catalyzing process 34, and/or an activating process 35, to allow copper or bronze materials or nickel materials to be applied or attached or deposited or electroplated onto the base member 10 in a non-electroplating process 36 without electricity or electric energy.

The base member 10 may then be subjected with a coloring process 37, to apply one or more colors onto the base member 10, and to generate various colors when the identifying or anti-infringing device 21 is lighted by the infrared-ray or laser beam generating device 90. The base member 10 may then be subjected with an electroplating process 38 for applying or depositing or electroplating a copper or bronze layer onto the base member 10, and/or one (39) or more (40) electroplating processes for applying or depositing or electroplating one (39) or more (40) nickel layers onto the base member 10.

The base member 10 may thus be applied thereto or formed with one or more color layers, and/or one or more copper or bronze layers, and/or one or more nickel layers, for allowing the base member 10 to have fine or delicate words, patterns or symbols or mark pieces 20 and/or fine or delicate identifying or anti-infringing device 21 formed therein.

Accordingly, the mark device in accordance with the present invention includes an identifying or anti-infringing device provided therein for identifying the truthfulness or authenticity of the mark device, and for preventing unauthorized persons from imitating or copying the mark device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A mark device comprising:
at least one mark piece, and
an identifying device provided in said at least one mark piece, for identifying whether said at least one mark piece is true or authentic or not.

2. The mark device as claimed in claim 1, wherein said identifying device includes at least one reduced mark piece provided in said at least one mark piece.

3. The mark device as claimed in claim 1 further comprising a light generating device for lighting onto said identifying device, to allow said identifying device to be seen by people.

4. The mark device as claimed in claim 1 further comprising a magnifying device for magnifying said identifying device, to allow said identifying device to be seen by people.

5. A mark device comprising:
a base member,
a mark including at least one mark piece provided on said base member, and
an identifying device for identifying whether said at least one mark piece is true or authentic or not.

6. The mark device as claimed in claim 5, wherein said identifying device includes at least one reduced mark piece provided in said at least one mark piece.

7. The mark device as claimed in claim 5, wherein said identifying device includes at least one reduced mark piece provided in said base member.

8. The mark device as claimed in claim 5 further comprising a light generating device for lighting onto said identifying device, to allow said identifying device to be seen by people.

9. The mark device as claimed in claim 5 further comprising a magnifying device for magnifying said identifying device, to allow said identifying device to be seen by people.
